(19) United States
(12) Patent Application Publication
(10) Pub. No.: US 2021/0284030 A1
(43) Pub. Date: Sep. 16, 2021

(54) ELECTRICAL VEHICLE CONTROL SYSTEM AND METHOD OF OPERATION

(71) Applicant: DE INNOVATION LAB LIMITED, Warwickshire (GB)

(72) Inventor: Albert Lam, Warwickshire (GB)

(21) Appl. No.: 16/605,130

(22) PCT Filed: Apr. 12, 2018
(86) PCT No.: PCT/IB2018/052564

§ 371 Date: Oct. 14, 2019

(30) Foreign Application Priority Data
Apr. 13, 2017 (GB) 1706023.7

(51) Int. Cl. B60L 15/20; B60R 16/023; G07C 5/08; B60L 58/12; G07C 5/00; B60L 1/00; H04L 29/08

(52) U.S. Cl. CPC B60L 15/2009; B60R 16/0231; G07C 5/0816; B60L 58/12; G07C 5/085; B60L 2240/34; B60L 1/00; H04L 67/125; B60L 2260/20; B60L 2240/60; B60L 2250/16; G07C 5/008

(57) ABSTRACT

Disclosed is an electrical vehicle control system for an electrical vehicle. The electrical vehicle control system includes a first system layer for hosting a software application management and infotainment arrangement for providing a graphical user interface for controlling operating parameters by a user of the electrical vehicle, a second system layer for communicating operational data between functional modules of the electrical vehicle, and a third modular layer including the functional modules of the electrical vehicle, wherein the first system layer is operable to control operating parameters provided by the second system layer for controlling driving characteristics of the electrical vehicle, wherein the driving characteristics include at least one of a selection of automatic or manual drive-train manners of operation, acceleration characteristics of the motor controller when providing power in operation to an electrical motor of the electrical vehicle, demand response functionality provided by the electrical vehicle when connected to a power grid, a manner of electrical power transfer between the battery unit and the electrical motor when the electrical vehicle is driven in operation and an economy of power utilization within the electrical vehicle in respect of cabin heating and battery unit charge depletion; and the second system layer includes a data communication bus for exchanging data between the functional modules, and the data communication bus is operable to provide data to the first system layer for the software application management and infotainment arrangement (SAMI) to perform data analysis, strategic control and/or reporting to a user of the electrical vehicle.

### TECHNICAL FIELD

The present disclosure relates to electrical vehicle control systems. Moreover, the present disclosure is concerned with methods of operating aforesaid electrical vehicle control systems. Furthermore, the present disclosure relates to software products stored on machine-readable data storage media and executable upon computing hardware for implementing aforesaid methods.

### BACKGROUND

Conventionally, pure electrical vehicles, and also hybrid vehicles including a combination of electric motor and internal combustion engine arrangements, are well known. Generally, in comparison to simple internal combustion engine vehicles and early designs of basic electrical vehicles, modern electrical vehicles are held to require a higher standard of performance. For example, modern electrical vehicles are expected to offer a higher range of functionality than conventional vehicles. Such higher standard of performance is necessary in order to make electrical vehicles attractive for modern consumers, to encourage users to switch from using polluting internal combustion engine vehicles to cleaner electrical vehicles (assuming electrical power generation derives from clean renewable energy sources, unlikely highly polluting conventional nuclear and fossil fuel burning energy sources).

However, an ability of the modern electrical vehicles to offer more functionality usually comes at a cost of complexity of associated systems. For example, a user of the electrical vehicle may be required to exert a substantial amount of effort to learn to operate the systems associated with the electrical vehicle (such as systems responsible for charge control of the electrical vehicle, temperature control, navigation, and so forth). Furthermore, a reliability of the provided functionality may be reduced due to the user having to remember how to operate properly the various systems. Additionally, the user having to maintain multiple functionalities during operation of the electrical vehicle may lead to an unpleasant experience for the user.

Therefore, there arises a technical problem of how to implement a system for an electrical vehicle in a most effective manner that is straightforward for users to employ, and also operable to provide useful and helpful information to users and to assist in providing a pleasurable and safe driving experience.

### SUMMARY

The present disclosure seeks to provide an improved electrical vehicle control system, namely an improved electrical vehicle software-based management and infotainment (SAMI) system.

Moreover, the present invention seeks to provide an improved method of operating an electrical vehicle control system for an electrical vehicle, namely an improved electrical vehicle software-based management and infotainment (SAMI) system.

According to a first aspect, there is provided an electrical vehicle control system for an electrical vehicle, wherein the electrical vehicle control system includes:
(i) a first system layer for hosting a software application management and infotainment arrangement (SAMI) for providing a graphical user interface for controlling operating parameters by a user of the electrical vehicle;
(ii) a second system layer for communicating operational data between functional modules of the electrical vehicle; and
(iii) a third modular layer including the functional modules of the electrical vehicle,

wherein
(A) the first system layer is operable to control operating parameters provided by the second system layer for controlling driving characteristics of the electrical vehicle, wherein the driving characteristics include at least one of:
   (i) a selection of automatic or manual drive-train manners of operation;
   (ii) acceleration characteristics of the motor controller when providing power in operation to an electrical motor of the electrical vehicle;
   (iii) demand response functionality provided by the electrical vehicle when connected to a power grid (242);
   (iv) a manner of electrical power transfer between the battery unit (220) and the electrical motor (230) when the electrical vehicle is driven in operation; and
   (v) an economy of power utilization within the electrical vehicle in respect of cabin heating and battery unit (220) charge depletion; and
(B) the second system layer includes a data communication bus for exchanging data between the functional modules, and the data communication bus is operable to provide data to the first system layer for the software application management and infotainment arrangement (SAMI) to perform data analysis, strategic control and/or reporting to a user of the electrical vehicle.

In an embodiment of the first aspect the functional modules are communicably coupled with a sensor arrangement for measuring one or more sensor signal parameters associated with the functional modules.

The present disclosure seeks to provide an electrical vehicle control system, which is easy to implement and straight forward for user to employ. Specifically, the electrical vehicle control system is operable to assist in providing a pleasurable and safe driving experience.

According to a second aspect, there is provided a method of operating an electrical vehicle control system for an electrical vehicle, wherein the method includes:
(i) using a first system layer of the electrical vehicle control system for hosting a software application management and infotainment arrangement (SAMI) for providing a graphical user interface for controlling of operating parameters by a user of the electrical vehicle;
(ii) using a second system layer of the electrical vehicle control system for communicating operational data between functional modules of the electrical vehicle; and
(iii) using a third modular layer including the functional modules of the electrical vehicle,

wherein
(A) the first system layer is operable to control operating parameters provided by the second system layer for controlling driving characteristics of the electrical vehicle, wherein the driving characteristics include at least one of:
   (i) a selection of automatic or manual drive-train manners of operation;
   (ii) acceleration characteristics of the motor controller when providing power in operation to an electrical motor of the electrical vehicle;
   (iii) demand response functionality provided by the electrical vehicle when connected to a power grid (242);
   (iv) a manner of electrical power transfer between the battery unit (220) and the electrical motor (230) when the electrical vehicle is driven in operation; and
   (v) an economy of power utilization within the electrical vehicle in respect of cabin heating and battery unit (220) charge depletion; and
(B) the second system layer includes a data communication bus for exchanging data between the functional modules, and the data communication bus is operable to provide data to the first system layer for the software application management and infotainment arrangement (SAMI) (114) to perform data analysis, strategic control and/or reporting to a user of the electrical vehicle.

In an embodiment of the second aspect the functional modules are communicably coupled with a sensor arrangement for measuring one or more sensor signal parameters associated with the functional modules.

According to a third aspect, there is provided a software product recording on machine-readable data storage media, wherein the software product is executable upon computing hardware for implementing a method of operating an electrical vehicle control system for an electrical vehicle.

It will be appreciated that features of the invention are susceptible to being combined in various combinations without departing from the scope of the invention as defined by the appended claims.

The present invention is included in the general business context, which aims to substitute vehicles powered by traditional fuels, for example gasoline or diesel, by electric vehicles. In particular, the present invention is intended for use in electric vehicles used within cities, which can be highly beneficial to the local environment due to significant reduction of gaseous emissions as well as significant reduction of noise. Overall environmental benefits can also be significant when electric vehicles are charged from renewable energy sources.

### DESCRIPTION OF THE DIAGRAMS

Embodiments of the present disclosure will now be described, by way of example only, with reference to the following diagrams wherein:

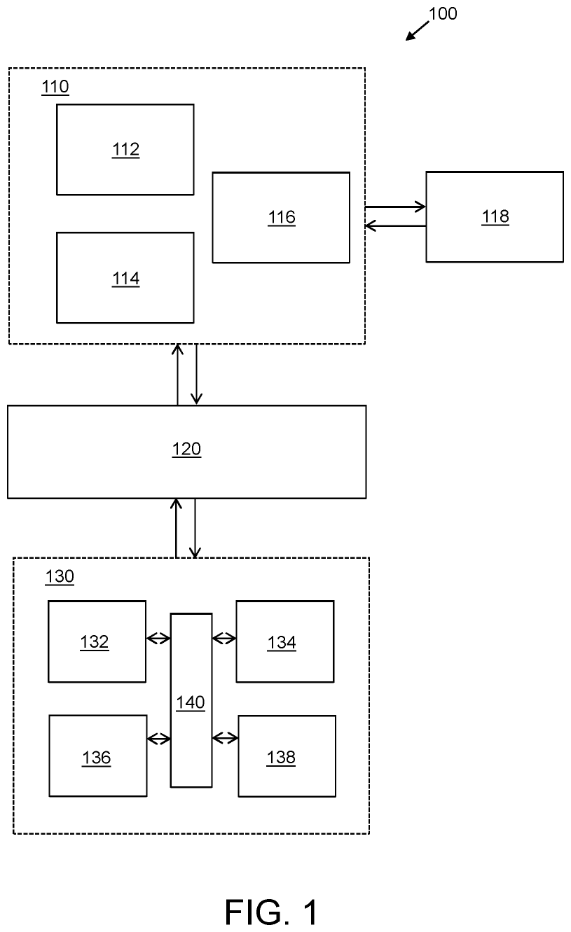

FIG. 1 is a block diagram of a system of an electrical vehicle, in accordance with an embodiment of the present disclosure;

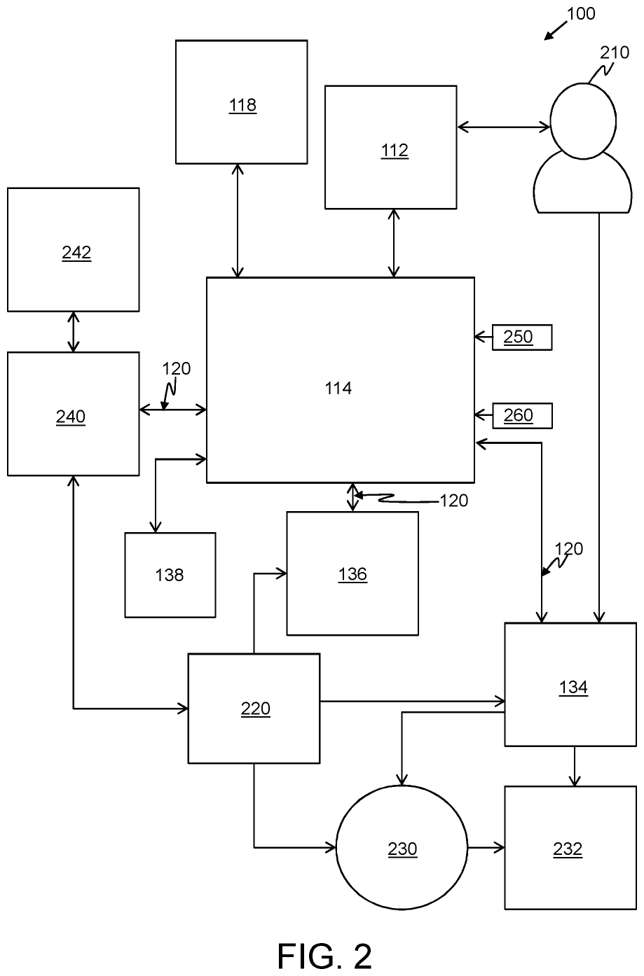

FIG. 2 is a block diagram illustrating components of electrical vehicle control system of FIG. 1, in accordance with an embodiment of the present disclosure; and

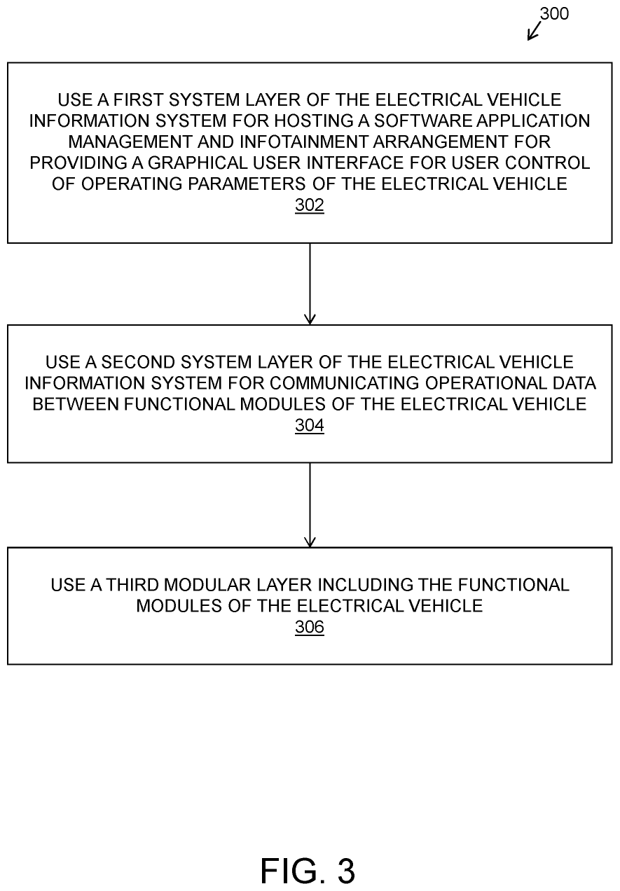

FIG. 3 illustrates steps of a method of operating an electrical vehicle control system for an electrical vehicle, in accordance with an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments of the present disclosure are concerned with electrical vehicle control systems, wherein the electrical vehicle control systems are implemented in a layered hierarchical manner for ensuring operational robustness at one or more lower layers of such a hierarchy handling specific specialist functions of electrical vehicles (for example motor control, battery charging, braking), and a wide spectrum of data analysis, information presentation and control at one or more higher layers of the hierarchy. There is thereby achieved robustness and reliability in operation, whilst providing a degree of operational flexibility and comprehensive analysis of overall electrical vehicle operation.

Referring to FIG. 1, there is shown a block diagram of an electrical vehicle control system 100 for an electrical vehicle, in accordance with an embodiment of the present disclosure. As shown, the system 100 includes a first system layer 110 that further includes a graphical user interface (GUI) 112, a software application management and infotainment arrangement 114, and a network interface 116; a second system layer 120; a third modular layer 130 including a braking arrangement 132, a motor control arrangement 134, a battery management system 136 and a cabin environmental control module 138_{L} sensor arrangement 140; and external resources 118.

The sensor arrangement 140 is communicably coupled with the functional modules 132-138 of the third modular layer 130, and the sensor arrangement 140 is operable to measure one or more sensor signal parameters associated with the functional modules 132-138. The first system layer 110 of the electrical vehicle control system 100 is operable to control operating parameters provided by the second system layer 120 for controlling driving characteristics of the electrical vehicle. The driving characteristics include a manner of electrical power transfer between a battery unit 220 and the electrical motor 230 when the electrical vehicle is driven in operation. Further, the second system layer 120 includes a data communication bus for exchanging data between the functional modules 132-138, and the data communication bus is operable to provide data to the first system layer 110 for the software application management and infotainment arrangement (SAMI) 114 to perform data analysis, strategic control and/or reporting to a user of the electrical vehicle.

The first system layer 110 is configured to host a software application management and infotainment arrangement (SAMI) 114 for providing a graphical user interface (GUI) 112 for user control of operating parameters of the electrical vehicle. In an embodiment, the term ‘system layer’ used herein relates to an internal structure and/or module, and/or technology. Specifically, the first system layer 110 may be hardware, software, firmware, or a combination of these, configured to execute the software application management and infotainment arrangement 114, thereon. For example, the first system layer 110 may include a carputer, laptop computers, tablet computers, phablet computers, and so forth.

In an embodiment, the term ‘software application management and infotainment arrangement’ used herein relates to a device-functionality software and/or an operating system software configured to execute other application programs and interface between the application programs and associated hardware (such as display, processor, memory, CAN bus, sensor and so forth). Specifically, the software application management and infotainment arrangement 114 may be a computing platform wherein a plurality of computer programs may be installed. More specifically, the software application management and infotainment arrangement 114 may be operable to accept data for performing data analysis, strategic control and reporting to a user of the electrical vehicle. In an embodiment, the system software defined herein may include a firmware and operating system that may be executed by a single and/or a plurality of processors. In such embodiment, the term ‘firmware’ used herein relates to processor routines that are stored in non-volatile memory structures such as read only memories (ROMs), flash memories, and so forth. Furthermore, the operating system may interact with the firmware for providing the computing platform in which plurality of computer programs may be installed and executed. In an example, the software application management and infotainment arrangement 114 may be operating within a carputer of a car (such as an electrical vehicle). In such example, the software application management and infotainment arrangement 114 may be operable to provide a computing platform for processing sensory information related to the vehicle, for reporting to a user of the vehicle and for providing strategic control for the vehicle. In such example, the software application management and infotainment arrangement 114 may be operable to provide an infotainment arrangement and/or system for the user of the vehicle, such as managing and playing audio content, utilizing navigation for driving, delivering entertainment such as movies, games, social networking, etc., listening to text messages, making phone calls, and accessing web-based content such as traffic conditions, sports scores and weather forecasts and so forth. Additionally, the software application management and infotainment arrangement 114 may acquire input from the user of the electrical vehicle via the graphical user interface 112.

In an embodiment, the graphical user interface 112 facilitates interaction between a user (such as a user of the electrical vehicle) and the software application management and infotainment arrangement 114. Specifically, the first system layer 110 renders the graphical user interface (GUI) 112 upon the execution of the software application management and infotainment arrangement 114 to acquire input from the user and provide the user with an output.

In an embodiment, the graphical user interface 112 may include control options, on-screen keyboards and pull-down menus to receive input from the user. Specifically, the user may interact with the graphical user interface (GUI) 112 by employing voice input, keypad input, gesture input, and so forth. For example, the user may input information to the graphical user interface 112 in the form of a gesture via a keypad input. In such example, the keypad input may be provided via a virtual keyboard and/or a physical keyboard. Furthermore, the user interface may consequently interact with the user by employing text output, voice output, image output, and so forth.

Optionally, the term “sensor signal parameters” as used herein relates to parameters associated with the functional modules 132-138.

In an embodiment, the first system layer 110 further comprises a network interface 116 for communicating with external resources 118. Specifically, the network interface 116 establishes communication between the software application management and infotainment arrangement (SAMI) 114 and the external resources 118. In an embodiment, the term ‘network interface’ used herein relates to a wired and/or wireless communication means comprising a software component, a hardware component, a network adapter component, a communication network and a combination thereof. In an example, the communication network used by the first system layer 110 may include Bluetooth®, Internet of things (IoT), Visible Light Communication (VLC), Near Field Communication (NFC), Local Area Networks (LANs), Wide Area Networks (WANs), Metropolitan Area Networks (MANs), Wireless LANs (WLANs), Wireless WANs (WWANs), Wireless MANs (WMANs), the Internet, telecommunication networks, radio networks, and so forth. In an embodiment, the term ‘external resources’ used herein relates to a hardware, software, firmware, or a combination of these, configured to store, process and/or share data. Specifically, the external resources 118 is operable to couple communicatively with the first system layer 110 to exchange data with the software application management and infotainment arrangement (SAMI) 114. More specifically, a user of the electrical vehicle may use the software application management and infotainment arrangement (SAMI) 114 to exchange data with the external resources 118. In an example, the external resources 118 may be a cloud service providing storage of data related to the electrical vehicle, processing data related to the electrical vehicle, sharing the data related to the electrical vehicle with the first system layer 110, and a combination thereof. In another example, the external resources 118 may be handheld electronic devices used by the user, operable to couple communicatively with the first system layer 110, such as, media player, mobile phone, personal assistance device, and so forth.

The second system layer 120 may provide operating parameters to the first system layer 110 for controlling driving characteristics of the electrical vehicle. The driving characteristics of the electrical vehicle include a manner of electrical power transfer between a battery unit 220 and the electrical motor 230, when the electrical vehicle is driven in operation.

The second system layer 120 is configured to communicate operational data between functional modules of the electrical vehicle. Specifically, the second system layer 120 may include a data communication bus for proving data communication within the system 100. In an example, the second system layer 120 may include a Controller Area Network to allow communication between various electronic components of the vehicle (such as: control units, devices, sensors, actuators and so forth). In such example, Controller Area Network may use a single or dual-wire network data bus for transferring operational data between the functional modules (explained herein later in greater details) of the vehicle. In an embodiment, the term ‘operational data’ used herein relates to the information and/or data provided by the functional modules of the vehicle. Furthermore, the operational data may be information related to the various component of the vehicle, such as a battery unit, cabin temperature, sensory data and so forth. In an embodiment, the second system layer 120 may be operable to communicate operational data between the first system layer 110 and the third modular layer 130 of the system 100. In another embodiment, the second system layer 120 may be operable to communicate operational data between the functional modules of the third modular layer 130 of the system 100. In an example, the data communication bus of the second system layer 120 may provide a data communication network between the functional modules of the third modular layer 130, and the software application management and infotainment arrangement 114 of the first system layer 110.

The third modular layer 130 is configured to include the functional modules of the electrical vehicle. The term ‘modular layer’ used herein relates to an internal structure and/or module configured to control the operation of the electrical vehicle. Specifically, the third modular layer 130 may be operable to implement functional modules to the electrical vehicle. In an embodiment, the term ‘functional modules’ used herein may be related to hardware, software, firmware, or a combination of these, configured to receive and store operational data from the functional elements of the electrical vehicle, such as brakes, electrical motor, clutch and gearbox, battery unit, and so forth. In an embodiment, the functional modules (explained herein later in greater details with FIG. 2) of the electrical vehicle may include:
(i) a braking arrangement 132 that may be configured to control braking of the electrical vehicle when driven in operation;
(ii) a motor control arrangement 134 that may be configured to control power delivered to an electrical motor for propelling the electrical vehicle when in operation;
(iii) a battery management system 136 that may be configured to control discharging and charging of a battery unit of the electrical vehicle, wherein the battery unit is operable to provide operating power to the electrical vehicle; and
(iv) a cabin environmental control module 138 may be configured to control a cabin temperature of the electrical vehicle.

The data communication bus of the second system layer 120 is used to exchange data between the functional modules. Specifically, the data communication bus of the second system layer 120 is operable to exchange the operational data provided with the functional modules (such as the functional modules 132 to 138). In an example, when the braking arrangement 132 is employed, operational data is being sent via the data communication bus of the second system layer 120 to the motor control arrangement 134 to restrict power to be delivered to an electrical motor propelling the electrical vehicle when in operation.

The data communication bus of the second system layer 120 is operable to provide data to the first system layer 110 for the software application management and infotainment arrangement 114 to perform data analysis, strategic control and reporting to a user of the electrical vehicle. Specifically, the data communication bus of the second system layer 120 is operable to provide operational data from the functional modules (such as the functional modules 132 to 138) of the third modular layer 130 to the software application management and infotainment arrangement 114 of the first system layer 110. In an example, the electrical vehicle may be travelling at a speed X to a destination ABC, which may be at a distance L from an origin, and which may be consuming the electrical charge at a rate of H. In such example, the data communication bus of the second system layer 120 may be operable to provide the software application management and infotainment arrangement 114 of the first system layer 110 with the information related to the speed of the vehicle and its related consumption of electrical charge, from the functional modules such as the motor control arrangement 134 and the battery management system 136. Furthermore, in such example, the software application management and infotainment arrangement 114 may analyse the possibility of electrical vehicle to reach the destination ABC at a speed X and suggest the user of the electrical vehicle with a strategic control of the electrical vehicle, such as suggest the user to travel at speed T, which may be lesser then initial speed X of the electrical vehicle. Furthermore, in such example the software application management and infotainment arrangement 114 may also report the user about any potential destination (such as a charging station) in the route to the destination ABC.

In an embodiment, the second system layer 120 is operable to couple user control signals directly from the user to the third modular layer 130, when the control signals relate to safety critical functions during driving of the electrical vehicle. The term ‘control signal’ used herein relates to the vehicle operational function provided by the user of the electronic vehicle for controlling a function of the vehicle. In an example, the user operation signal such as the application of brakes to stop movement of the vehicle will be directly sent to the braking arrangement 132 of the third modular layer 130.

In an embodiment, the driving characteristics may include but not limited to a selection of automatic or manual drive-train manners of operation; acceleration characteristics of the motor controller when providing power in operation to an electrical motor of the electrical vehicle; demand response functionality provided by the electrical vehicle when connected to a power grid 242; a manner of electrical power transfer between the battery unit 220 and the electrical motor 230 when the electrical vehicle is driven in operation; and an economy of power utilization within the electrical vehicle in respect of cabin heating and battery unit 220 discharge.

In an exemplary embodiment, an operating parameter may be a binary selection of manual or automatic transmission as a stored binary digit parameter in the second system layer. Another example could be selection of a “sport mode” or “economy” mode of driving as a stored parameter in the second system layer.

In another exemplary embodiment, a responsive operating parameter may be a temperature dependent parameter that is supplied information from a sensor communicating with the first system layer, such parameter stored on the second system layer, but controlled from the first system layer, to influence communicated data between functional modules in the third system layer.

In an embodiment, the first system layer 110 may be operable to control operating parameters received from the second system layer 120, for controlling driving characteristics of the electrical vehicle. As aforementioned, the data communication bus of the second system layer 120 is operable to exchange the operational data provided with the functional modules, for example operational data is sent from the braking arrangement to the motor control arrangement. In an event of purely direct communication, the response may be on the basis of a predefined program. However, it is advantageous if the user or other functions in the car that can sense a changed situation can control such a communication by providing the second system layer with parameters to influence the response without having to revert to the first system layer.

In an embodiment, the software application management and infotainment arrangement (SAMI) 114 may use the sensor signal parameters received from the sensor arrangement 140 based on changes in conditions outside the cabin of the electrical vehicle via the second system layer 120, and may recommend the driving characteristics to the user of the electrical vehicle based on the measured conditions outside the cabin of the electrical vehicle. This embodiment is advantageous in terms of efficient and optimal use of battery unit 220.

In an embodiment, the conditions outside the cabin of the electrical vehicle may include but not limited to environmental conditions, road conditions, traffic conditions, and visibility.

In an embodiment, the first system layer 110 is operable to monitor for fault conditions developing in the second and third system layers, by comparing against historical sensor data stored by the first system layer in data memory. The term ‘fault conditions’ used herein relate to the malfunctioning of the functional elements of the electrical vehicle, such as data communication bus, brakes, electrical motor, clutch and gearbox, battery unit, and so forth. In an embodiment, the functional elements of the electrical vehicle may be coupled with a sensory arrangement, that are operable to provide the data related to the operation of the functional elements to the first system layer 110 for monitoring. Furthermore, in such embodiment, the data related to the operation of the functional element may be provided to the software application management and infotainment arrangement 114 of the first system layer 110 for analysis. In an example, the motor control arrangement 134 of the third modular layer 130 may be coupled with a sensory arrangement, that is operable to provide operational data to the software application management and infotainment arrangement 114 of the first system layer 110. In such example, the operational data related to the motor control arrangement 134 may be related to the time required to slow down the electrical motor propelling the electrical vehicle when in operation. Furthermore, in such an example, every time the electrical motor slows down, the time required is stored in the data memory of the software application management and infotainment arrangement 114. Therefore, in the event when the time required by the electrical motor to slow down is more than a predefined threshold value, the software application management and infotainment arrangement 114 may identify the event as a fault condition. Optionally, the software application management and infotainment arrangement 114 may notify the user of the electrical vehicle via the graphical user interface (GUI) 112 about the fault condition related to the motor control arrangement 134 of the electrical vehicle.

In an embodiment, the first system layer 110 is operable to organize rescue, maintenance and servicing schedules for the electrical vehicle, based upon sensor data received from the second system layer 120 and/or from the third system layer 130. Specifically, the rescue, maintenance and servicing schedules for the electrical vehicle may be related to an appointment made for the electrical vehicle, with service providers providing the services of rescue, maintenance and servicing for electrical vehicles. In an example, the software application management and infotainment arrangement 114 may be operable to contact an electrical vehicle repairing service provider for providing maintenance to the electrical vehicle, in the event of the detecting a fault condition in the electrical vehicle, or an onset of a fault condition likely to occur in future. In another example, the software application management and infotainment arrangement 114 may be operable to automatically book/reserve a time slot for the charging of the electrical vehicle at a nearest charging station, in the event when the software application management and infotainment arrangement 114 detects a lesser amount of charge in the electrical vehicle. In yet another example, the software application management and infotainment arrangement 114 of the electrical vehicle may be operable to send a rescue signal (such as SOS) to the service provide providing the rescue service to electrical vehicles in the event of an accident or breakdown of the electrical vehicle.

In an embodiment, the first system layer 110 is operable to organize a vehicle driving route for the electrical vehicle in response to user instructions and a state of charge of the battery unit of the electrical vehicle. For example, the software application management and infotainment arrangement 114 of the electrical vehicle may be operable to derive a route to a destination selected by a user of the electrical vehicle. In such example, the software application management and infotainment arrangement 114 may be operable to provide the user with a navigation application such as SATNAV, wherein the user may select a destination for travelling thereto. Furthermore, in such an example, the software application management and infotainment arrangement 114 may be operable to detect the amount of charge required by the electrical vehicle for travelling to the destination. Additionally, the software application management and infotainment arrangement 114 may suggest the user of the electrical vehicle to charge the battery of the electrical vehicle before travelling and/or suggest the user to charge the electrical vehicle after travelling a certain distance (using a nearest charging station). Optionally, the software application management and infotainment arrangement 114 may be operable to suggest the user of the electrical vehicle to drive with a specific speed or in a specific mode of travelling (such as an “economy mode”).

Referring to FIG. 2, there is illustrated a block diagram of components of the electrical vehicle control system 100 of FIG. 1, in accordance with an embodiment of the present disclosure. As shown, the electrical vehicle control system 100 comprises the software application management and infotainment arrangement 114 that may acquire input from a user 210 of the electrical vehicle via the graphical user interface (GUI) 112. Optionally, the software application management and infotainment arrangement 114 included in the first system layer is operable to control operating parameters of the second system layer, for controlling driving characteristics of the electrical vehicle. Optionally, such input by the user 210 may include a selection of automatic or manual drive-train manners of operation. For example, the user 210 may make the selection of automatic drive-train manner of operation that may include “drive”, “reverse” and “park” modes of control of the electrical vehicle. In another example, the user 210 may make the selection of manual drive-train manner of operation that may enable the user to make one of four gear choices (and optionally one or more reverse gears) related to different driving speeds of the electrical vehicle.

Specifically, the first system layer 110 is operable to control operating parameters that is to be communicated by the second system layer 120, for controlling driving characteristics of the electrical vehicle. More specifically, the software application management and infotainment arrangement (SAMI) 114 hosted by the first system layer 110 is operable to control operating parameters that is to be communicated by the second system layer 120. Furthermore, the operating parameter that is to be communicated by the second system layer 120 refers to the data in the operational data that defines the terms of communicating the information to and/or from the functional modules of the electric vehicle. In an example, the operating parameter that is to be communicated may include terms of segmenting the information electric vehicle (namely the information of the functional modules). In another example, the operating parameter that is to be communicated may include selectively transferring the segmented data. In another example, the operating parameter that is to be communicated may include instruction to manipulate the operational data. In yet another example, the operating parameter that is to be communicated may include a time period upon which the data is to be communicated.

Furthermore, the electrical vehicle control system 100 is communicably coupled to the third modular layer (such as the third modular layer 130 of FIG. 1) comprising the battery management system 136 of the electrical vehicle for controlling discharging and charging of a battery unit 220 of the electrical vehicle, wherein the battery unit 220 is operable to provide operating power to the electrical vehicle. As shown, the battery unit 220 is communicably coupled to the motor control arrangement 134 of the electrical vehicle for controlling power delivered to an electrical motor 230 for propelling the electrical vehicle when in operation. Optionally, the software application management and infotainment arrangement 114 may be operable to control a manner of electrical power transfer between the battery unit 220 and the electrical motor 230 when the electrical vehicle is driven in operation. For example, when the user 210 of the electrical vehicle depresses an accelerator pedal (not shown) of the electrical vehicle, a signal indicative of mechanical movement of the accelerator pedal is sent to the software application management and infotainment arrangement 114. In such instance, the software application management and infotainment arrangement 114 is operable to provide electrical power from the battery unit 220 to the electrical motor 230 to accelerate the electrical vehicle. Optionally, the software application management and infotainment arrangement 114 is operable to control acceleration characteristics of the motor controller when providing power in operation to an electrical motor of the electrical vehicle. For example, in an “economy mode” of operation of the electrical vehicle, the software application management and infotainment arrangement 114 may be operable to provide less power to the electrical motor 230 in response to user depression of the acceleration, when compared to a “sport mode” of operation when the software application management and infotainment arrangement 114 is operable to provide relatively more power to the electrical motor 230 to control acceleration of the electrical vehicle.

Additionally, the motor control arrangement 134 is communicably coupled to a clutch arrangement, a gearbox arrangement and a differential gear arrangement, indicated generally by 232, that is operable to control an output torque provided to wheels of the electrical vehicle. Moreover, the clutch arrangement, the gearbox arrangement and the differential gear arrangement 232 are operable to be controlled by the user 210 of the vehicle, for example, using a clutch-pedal, a gear-change lever and a steering arrangement (not shown) of the electrical vehicle.

Furthermore, the software application management and infotainment arrangement 114 is communicably coupled to the cabin environmental control module 138 of the electrical vehicle, for controlling a cabin temperature of the electrical vehicle. For example, the cabin environmental control module 138 may be operable to provide heating in a cabin of the vehicle based on a temperature of the cabin of the vehicle. Optionally, the software application management and infotainment arrangement 114 may be operable to control an economy of power utilization within the electrical vehicle in respect of cabin heating and battery unit charge depletion. For example, the software application management and infotainment arrangement 114 may be operable to determine an amount of charge remaining in the battery unit 220. In such an instance, response to determination of an insufficient charge in the battery unit 220, the software application management and infotainment arrangement 114 may be operable to utilize waste heat from the battery unit 220 to provide heating in the cabin of the electrical vehicle.

Additionally, as shown the software application management and infotainment arrangement 114 is communicably coupled to a power switching unit 240 that is further coupled to a power grid 242. The software application management and infotainment arrangement 114 is operable to communicate to the power switching unit 240 to allow, for example, power to be drawn from the power grid 242 to be provided to the battery unit 220 and a home of the user, or to allow power to be drawn from the battery unit 220 to provide power to the home of the user. Optionally, the software application management and infotainment arrangement 114 may be operable to control demand response functionality provided by the electrical vehicle when connected to a power grid 242. For example, the software application management and infotainment arrangement 114 may be operable to receive information indicative of the power grid 242 experiencing a high power demand (or becoming overloaded in operation) and, in response to such a condition, the software application management and infotainment arrangement 114 may be operable to instruct the power switching unit 240 to draw power from the electrical vehicle to provide demand response to the power grid 242.

Moreover, as shown, the software application management and infotainment arrangement 114 is coupled to a GPS module 250 that may enable a geographical location of the electrical vehicle to be determined. Additionally, the software application management and infotainment arrangement 114 is coupled to GPRS module 260 that may enable the user 210 to communicate wirelessly with the software application management and infotainment arrangement 114. Optionally, the software application management and infotainment arrangement 114 included in the first system layer is operable to organise a vehicle information log to be sent to a user on a user device, for remotely providing the user 210 with information regarding a status of the vehicle, wherein the status of the vehicle may be at least one of a geographical location of the vehicle, a state of charge of the battery unit 220 of the vehicle, and/or a cabin temperature of the vehicle. For example, the status of the vehicle may enable the user 210 to determine the geographical location of the vehicle in an event of theft thereof. In another example, the status of the vehicle may enable the user 210 to determine if there is a requirement of the electrical vehicle to be connected to a charging terminal to charge the battery unit 220 of the electrical vehicle. Optionally, the user device includes the remote graphical user interface 112 for the software application management and infotainment arrangement 114 to provide user control of the operating parameters of the electrical vehicle. In an example, the user device may comprise at least one of a smartphone, a tablet computer and/or a laptop computer and may comprise the graphical user interface (GUI) 112 to allow the user 210 to communicate with the software application management and infotainment arrangement 114, for example, using an input on a touchscreen or a keyboard of the user device. Optionally, the software application management and infotainment arrangement 114 included in the first system layer further comprises a network interface (such as the GPRS module 260) for communicating with external resources 118. In an embodiment, the network interface associated with the software application management and infotainment arrangement 114 included in the first system layer is operable to provide a plurality of infotainment content to the user, wherein the infotainment content includes at least one of media content, advertising and/or web-based content. For example, the software application management and infotainment arrangement 114 may allow the user 210 of the electrical vehicle to manage and playing audio content, utilize navigation for driving, deliver entertainment such as movies, games, social networking, and so forth, listening to text messages, making phone calls, and accessing web-based content such as traffic conditions, sports scores and weather forecasts and so forth. In another example, the software application management and infotainment arrangement 114 may provide advertising on the graphical user interface 112 based on the geographical location of the electrical vehicle, for example, advertising related to a restaurant in a vicinity of the user. In yet another example, the software application management and infotainment arrangement 114 may provide the user with a guided tour, highlighting sites of historical or cultural interest, based upon a geographical location of the electrical vehicle; optionally, the software application management and infotainment arrangement 114 is operable to be adaptively selective when presenting such a guided tour, depending upon a speed of travel of the vehicle.

In an exemplary embodiment, the software application management and infotainment arrangement (SAMI) 114 may be operable to provide the driver of the electrical vehicle with updates related to the amount of the distance that may be covered by the electrical vehicle based on the current state of charge of the battery unit 220.

Referring to FIG. 3, there are illustrated steps of a method 300 of operating an electrical vehicle control system (such as the electrical vehicle control system 100 of FIG. 1) for an electrical vehicle, in accordance with an embodiment of the present disclosure. At a step 302, a first system layer (such as the first system layer 110 of FIG. 1) of the electrical vehicle control system is used for hosting a software application management and infotainment arrangement for providing a graphical user interface for controlling of operating parameters by a user of the electrical vehicle. At a step 304, a second system layer (such as the second system layer 120 of FIG. 1) of the electrical vehicle control system is used for communicating operational data between functional modules of the electrical vehicle. At a step 306, a third modular layer (such as the third modular layer 130 of FIG. 1) is used, including the functional modules of the electrical vehicle. The first system layer 110 is operable to control operating parameters provided by the second system layer 120 for controlling driving characteristics of the electrical vehicle, wherein the driving characteristics include at least one of: a selection of automatic or manual drive train transmission modes of operation; acceleration characteristics of the motor controller when providing power in operation to an electrical motor of the electrical vehicle; response demand functionality provided by the electrical vehicle when connected to a power grid; a manner of electrical power transfer between the battery unit 220 and the electrical motor when the electrical vehicle is driven in operation; and an economy of power utilization within the electrical vehicle in respect of cabin heating and battery unit charge depletion. The second system layer 120 includes a data communication bus for exchanging data between the functional modules 132 to 138, and the data communication bus is operable to provide data to the first system layer 110 for the software application management and infotainment arrangement (SAMI) 114 to perform data analysis, strategic control and/or reporting to a user of the electrical vehicle.

The steps 302 to 306 are only illustrative and other alternatives can also be provided where one or more steps are added, one or more steps are removed, or one or more steps are provided in a different sequence without departing from the scope of the claims herein. For example, the second system layer 120 may be operable to couple user control signals directly from the user to the third modular layer 130, when the control signals relate to safety critical functions during driving of the electrical vehicle. In another example, the third modular layer 130 includes a braking arrangement(such as the braking arrangement 132 of FIG. 1) of the electrical vehicle for controlling braking of the electrical vehicle when driven in operation, a motor control arrangement (such as the motor control arrangement 134 of FIG. 1) of the electrical vehicle for controlling power delivered to an electrical motor for propelling the electrical vehicle when in operation, a battery management system (such as the battery management system 136 of FIG. 1) of the electrical vehicle for controlling discharging and charging of a battery unit of the electrical vehicle, wherein the battery unit is operable to provide operating power to the electrical vehicle, a cabin environmental control module (such as the cabin environmental control 138 of FIG. 1) of the electrical vehicle, for controlling a cabin temperature of the electrical vehicle, and a sensor arrangement (such as the sensor arrangement 140 of FIG. 1) for measuring one or more sensor signal parameters associated with the functional modules 132 to 138. In yet another example, the first system layer is operable to control operating parameters provided by the second system layer, for controlling driving characteristics of the electrical vehicle. Optionally, the driving characteristics include at least one of a selection of automatic or manual drive train transmission modes of operation, acceleration characteristics of the motor controller when providing power in operation to an electrical motor of the electrical vehicle, response demand functionality provided by the electrical vehicle when connected to a power grid, a manner of electrical power transfer between the battery unit and the electrical motor when the electrical vehicle is driven in operation, and/or an economy of power utilization within the electrical vehicle in respect of cabin heating and battery unit charge depletion. In an example, the first system layer is operable to monitor for fault conditions developing in the second and third system layers, by comparing against historical sensor data stored by the first system layer in data memory. Optionally, the first system layer is operable to organize rescue, maintenance and servicing schedules for the electrical vehicle, based upon sensor data received from the second system layer and/or from the third system layer. More optionally, the first system layer is operable to organize a vehicle driving route for the electrical vehicle in response to user instructions and a state of charge of the battery unit of the electrical vehicle. In another example, the first system layer is operable to organise a vehicle information log to be sent to a user on a user device, for remotely provide the user with information regarding a status of the vehicle. In yet another example, the user device further provides a remote graphical user interface of the software application management and infotainment arrangement for providing user control of the operating parameters of the electrical vehicle.

Furthermore, the method of operating the electrical vehicle control system for an electrical vehicle is implemented on a software product recording on machine-readable data storage media, characterized in that the software product is executable upon computing hardware

The electrical vehicle control system of the present disclosure allows user control signals to be coupled directly from the user to the third modular layer. Such a configuration allows the user to maintain control of safety critical functions (such as braking), in an event of a software glitch causing the software application management and infotainment arrangement to stop execution (namely, “hang up”). Furthermore, the software application management and infotainment arrangement included in the first system layer is operable to monitor for fault conditions developing in the second and third system layers. Such monitoring may allow a potential malfunction of a component of the second or third system layers to be identified before malfunctioning thereof and allow an appropriate action to be taken in response thereto, for example performing a maintenance operation on the vehicle. The software application management and infotainment arrangement included in the first system layer, that is operable to organize a vehicle driving route based upon a state of charge of the battery unit of the electrical vehicle, may reduce a chance of breakdown due to lack of charge in the battery unit of the electrical vehicle while travelling. Additionally, software application management and infotainment arrangement, that is operable to organise a vehicle information log to be sent to a user on a user device, allows the user to monitor remotely the electrical vehicle (such as to track the electrical vehicle in an event of theft thereof).

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An electrical vehicle control system (100) for an electrical vehicle, wherein the electrical vehicle control system (100) includes:
(i) a first system layer (110) for hosting a software application management and infotainment arrangement (SAMI) (114) for providing a graphical user interface (116) for controlling operating parameters by a user of the electrical vehicle;
(ii) a second system layer (120) for communicating operational data between functional modules (132 to 138) of the electrical vehicle; and
(iii) a third modular layer (130) including the functional modules (132 to 138) of the electrical vehicle,
wherein
(A) the first system layer (110) is operable to control operating parameters provided by the second system layer (120) for controlling driving characteristics of the electrical vehicle, wherein the driving characteristics include at least one of:
(i) a selection of automatic or manual drive-train manners of operation;
(ii) acceleration characteristics of the motor controller when providing power in operation to an electrical motor of the electrical vehicle;
(iii) demand response functionality provided by the electrical vehicle when connected to a power grid (242);
(iv) a manner of electrical power transfer between the battery unit (220) and the electrical motor (230) when the electrical vehicle is driven in operation; and
(v) an economy of power utilization within the electrical vehicle in respect of cabin heating and battery unit (220) charge depletion; and
(B) the second system layer (120) includes a data communication bus for exchanging data between the functional modules (132 to 138), and the data communication bus is operable to provide data to the first system layer (110) for the software application management and infotainment arrangement (SAMI) (114) to perform data analysis, strategic control and/or reporting to a user of the electrical vehicle.

2. An electrical vehicle control system (100) of claim 1, wherein the functional modules (132 to 138) are communicably coupled with a sensor arrangement (140) for measuring one or more sensor signal parameters associated with the functional modules (132 to 138).

3. An electrical vehicle control system (100) of claim 1, wherein the second system layer (120) is operable to couple user control signals directly from the user to the third modular layer (130), when the user control signals relate to safety critical functions during driving of the electrical vehicle.

4. An electrical vehicle control system (100) of claim 1, wherein the third modular layer (130) includes:
(i) a braking arrangement (132) of the electrical vehicle for controlling braking of the electrical vehicle when driven in operation;
(ii) a motor control arrangement (134) of the electrical vehicle for controlling power delivered to an electrical motor (230) for propelling the electrical vehicle when in operation;
(iii) a battery management system (136) of the electrical vehicle for controlling discharging and charging of a battery unit (220) of the electrical vehicle, wherein the battery unit (220) is operable to provide operating power to the electrical vehicle; and
(iv) a cabin environmental control module (138) of the electrical vehicle, for controlling a cabin temperature of the electrical vehicle.

5. An electrical vehicle control system of claim 1, wherein the first system layer (110) is operable to monitor for fault conditions developing in the second and third system layers (120, 130), by comparing against historical sensor data stored by the first system layer (110) in data memory.

6. An electrical vehicle control system of claim 5, wherein the first system layer (110) is operable to organize rescue, maintenance and servicing schedules for the electrical vehicle, based upon sensor data received from the second system layer (120) and/or from the third system layer (130).

7. An electrical vehicle control system of claim 1, wherein the first system layer (110) is operable to organize a vehicle driving route for the electrical vehicle in response to user instructions and a state of charge of the battery unit (220) of the electrical vehicle.

8. An electrical vehicle control system of claim 1, wherein the first system layer (110) is operable to organise a vehicle information log to be sent to a user on a user device, for remotely providing the user with information regarding a status of the vehicle.

9. An electrical vehicle control system of claim 8, wherein the user device includes a remote graphical user interface for the software application management and infotainment arrangement (SAMI) (114) to provide user control of the operating parameters of the electrical vehicle.

10. An electrical vehicle control system of claim 8, wherein the status of the vehicle may be at least one of: a geographical location of the vehicle, a state of charge of the battery unit (220) of the vehicle, a cabin temperature of the vehicle.

11. An electrical vehicle control system of claim 2, wherein the sensor arrangement (140) is communicably coupled with the software application management and infotainment arrangement (SAMI) (114), and operable for: measuring conditions outside a cabin of the electrical vehicle, and recommending the driving characteristics based on the measured conditions outside the cabin of the electrical vehicle.

12. A method of operating an electrical vehicle control system (100) for an electrical vehicle, wherein the method includes:
(i) using a first system layer (110) of the electrical vehicle control system (100) for hosting a software application management and infotainment arrangement (SAMI) (114) for providing a graphical user interface (112) for controlling of operating parameters by a user of the electrical vehicle;
(ii) using a second system layer (120) of the electrical vehicle control system (100) for communicating operational data between functional modules (132 to 138) of the electrical vehicle; and
(iii) using a third modular layer (130) including the functional modules (132 to 138) of the electrical vehicle,
wherein
(A) the first system layer (110) is operable to control operating parameters provided by the second system layer (120) for controlling driving characteristics of the electrical vehicle, wherein the driving characteristics include at least one of:
(i) a selection of automatic or manual drive train transmission modes of operation;
(ii) acceleration characteristics of the motor controller when providing power in operation to an electrical motor of the electrical vehicle;
(iii) response demand functionality provided by the electrical vehicle when connected to a power grid;
(iv) a manner of electrical power transfer between the battery unit (220) and the electrical motor when the electrical vehicle is driven in operation; and
(v) an economy of power utilization within the electrical vehicle in respect of cabin heating and battery unit charge depletion; and
(B) the second system layer (120) includes a data communication bus for exchanging data between the functional modules (132 to 138), and the data communication bus is operable to provide data to the first system layer (110) for the software application management and infotainment arrangement (SAMI) (114) to perform data analysis, strategic control and/or reporting to a user of the electrical vehicle.

13. A method as claimed in claim 12, wherein the functional modules (132 to 138) are communicably coupled with a sensor arrangement (140) for measuring one or more sensor signal parameters associated with the functional modules (132 to 138).

14. A method as claimed in claim 12, wherein the second system layer (120) is operable to couple user control signals directly from the user to the third modular layer (130), when the control signals relate to safety critical functions during driving of the electrical vehicle.

15. A method as claimed in claim 12, wherein the functional modules (132 to 138) of the third modular layer (130) includes:
(i) a braking arrangement (132) of the electrical vehicle for controlling braking of the electrical vehicle when driven in operation;
(ii) a motor control arrangement (134) of the electrical vehicle for controlling power delivered to an electrical motor for propelling the electrical vehicle when in operation;
(iii) a battery management system (136) of the electrical vehicle for controlling discharging and charging of a battery unit (220) of the electrical vehicle, wherein the battery unit (220) is operable to provide operating power to the electrical vehicle; and
(iv) a cabin environmental control module of the electrical vehicle, for controlling a cabin temperature of the electrical vehicle.

16. A method as claimed in claim 12, wherein the first system layer (110) is operable to monitor for fault conditions developing in the second and third system layers (120, 130), by comparing against historical sensor data stored by the first system layer (110) in data memory, wherein the first system layer (110) is operable to organize rescue, maintenance and servicing schedules for the electrical vehicle, based upon sensor data received from the second system layer (120) and/or from the third system layer (130).

17. A method as claimed in claim 12, wherein the first system layer (110) is operable to organize a vehicle driving route for the electrical vehicle in response to user instructions and a state of charge of the battery unit (220) of the electrical vehicle.

18. A method as claimed in claim 12, wherein the first system layer (110) is operable to organise a vehicle information log to be sent to a user on a user device, for remotely provide the user with information regarding a status of the vehicle.

19. A method as claimed in claim 18, wherein the user device further provides a remote graphical user interface of the software application management and infotainment arrangement (SAMI) (114) for providing user control of the operating parameters of the electrical vehicle.

20. A method of claim 13, wherein the sensor arrangement (140) is communicably coupled with the software application management and infotainment arrangement (SAMI) (114), and operable for: measuring conditions outside a cabin of the electrical vehicle, and recommending the driving characteristics based on the measured conditions outside the cabin of the electrical vehicle.
